(19) United States
(12) Patent Application Publication
(10) Pub. No.: US 2013/0298781 A1
(43) Pub. Date: Nov. 14, 2013

(54) Portable Passive Convection Cooking Oven

(71) Applicant: Eden Variety Products, LLC, Roselle, NJ (US)

(72) Inventors: Wilfredo Ganuza, Roselle, NJ (US); Juan Fernandez, Towaco, NJ (US)

(21) Appl. No.: 13/858,359

(22) Filed: Apr. 8, 2013

Related U.S. Application Data
(60) Provisional application No. 61/621,182, filed on Apr. 6, 2012.

(51) Int. Cl. A47J 37/06

(52) U.S. Cl. CPC A47J 37/0623
USPC 99/447

(57) ABSTRACT

Disclosed is a portable, passive-convection oven having a base containing a heat-distributing plate. A grill-plate is placed over the heating plate and a lid put on top. The lid, grill-plate and base each have a handle. A circular hole in the bottom of the base is sized to fit over a domestic stove heating element. A catchment rim running along the perimeter of the hole prevents liquid spilling into the hole. The convection plate has a convex heating surface elevated above the hole by a gap that allows heated air to flow up over the top of the heating surface. The heating surface extends out over the catchment rim. The grill-plate is positioned above the heat surface, and has a number of holes through it that allow heated air to rise through it and heat the items that are being cooked while supported by the grill-plate.

### CLAIM OF PRIORITY

This application claims the priority of U.S. Ser. No. 61/621,182 filed on Apr. 6, 2012, the contents of which are fully incorporated herein by reference.

### FIELD OF THE INVENTION

The invention relates to a cooking appliance, and more particularly to a portable, passive-convection cooking oven.

### BACKGROUND OF THE INVENTION

Stove top utensils typically cook food by conduction of heat from a heating element through the utensil to the food. In baking, the food and the heating element are contained in an oven, and radiant heat may be reflected from the walls of the oven, adding to the conducting heat, allowing higher temperatures to be obtained and hence, faster cooking of the food. A further refinement is to circulate the air within the oven, allowing heat to be transported by the hot air as well as conduction and radiating. This added heat transport makes a convection oven about 25% more effective than a conventional oven, i.e., food can be cooked in 25% less time. The circulating hot air also makes the heating significantly more even and allows the outer surfaces of the food to cook more quickly. This eliminates hot spots in the oven, and allows items such as, but not limited to, pizzas to be cooked with a crispier crust.

Problems with existing convection ovens are that the air typically has to be circulated by a fan driven by an electric motor. This necessitates cooking in the vicinity of an electric power outlet, making outdoor cooking challenging. The fans also tend to be noisy, a fact that can make cooking with a convection oven less desirable.

The present invention overcomes these problems by providing passive air circulation through innovative design of the components. The result is a portable, passive convection cooking oven that retains the advantages of a convectional convection oven while overcoming the disadvantages detailed above.

### DESCRIPTION OF THE RELATED ART

The relevant prior art involving convection ovens include:

U.S. Pat. No. 6,360,654 issued to Cornfield on Mar. 26, 2002 entitled “Multi-purpose cookware” that describes a cooker having a base unit and a cover. The cover includes a top and bottom ends. The bottom end has a circular edge extending straight and upwardly therefrom to form an annular wall. The annular wall further extends inwardly to form a top portion.

U.S. Pat. No. 6,196,115 issued to Tsao on Mar. 6, 2001 entitled “Structure of a multi-function cooking utensil” that describes a multi-function cooking utensil that simultaneously has the functions of frying, boiling, sautéing, deep-frying, and steaming food. It is composed of a pot member, a steaming member and a cover member. By means of a design of a fixing bolt on the upper rim of the cover member and the two lateral external sides of the steaming member and the pot member, users can change according to their need the detachable handle, or detachable grip, or detachable handle of the cover in order to lift the cooking utensil. In addition, by means of the design of several grooves of different depths in the internal rim of the lateral side of the steaming member and the pot member, and in compliance with several protruding rafters of a barbeque rack or a steaming tray provides the pot member and the steaming member several layers for cooking. Furthermore, by means of a plurality of steam holes deposed on the internal side of the bottom of the steaming member and a big hollow cavity from by stamping on the proper location, and a movable plate having several protruding rafters. Such arrangement allows the cooking utensil to have the steaming, boiling, deep-frying function. By the foregoing structural design with the mechanical parts, this invention can save energy and reduce the packing space, and further enhance the economic applicability effect.

U.S. Pat. No. 5,365,833 issued to Chen on Nov. 22, 1994 entitled “Pizza baking pan” that describes a pizza baking pan that includes a wok having a center through hole, a rack having an inside annular flange raised from a recessed center portion thereof and a plurality of vent holes around the border thereof surrounding the recessed center portion for passing heat, a ceramic baking plate supported on the inside annular flange inside the recessed center portion, and a dome cover covered on the rack over the ceramic baking plate and having a transparent lid in the center for viewing the inside of the pan.

US Patent Publication no. 20110236549 issued to Bedard on Sep. 29, 2011 entitled “Portable Cooking Device” that describes a portable cooking device suitable for baking foods such as pizza. The device can include a base with a cover, a fan mounted circulate air within the device, and a thermoelectric device for powering the fan.

Various related implements are, therefore, known in the art, but fail to address all of the problems solved by the invention described herein. One embodiment of this invention is illustrated in the accompanying drawings and will be described in more detail herein below.

### SUMMARY OF THE INVENTION

The present invention relates to a portable, passive-convection cooking oven.

In a preferred embodiment, the portable, passive-convection cooking oven may include a base structure containing a heat distributing convection plate over which a flat grill plate may be placed and a convex shaped lid to cover them all. The lid, flat grill plate and the base structure may each have a handle.

The base structure preferably has a flat base having circular hole. The circular hole may be shaped and sized to fit a domestic stove gas burner or electric heating ring, and the base may be made of a suitably heat conducting metal, alloy or ceramic, or a combination thereof.

The base may also have a side wall running long the entire outer perimeter, and a catchment rim running along the perimeter of the circular hole in the middle of the base, and one or more handles for lifting the base structure.

The heat distributing convection plate may have a convex or a conical heating surface that may be supported above a support ring by at least one elevating connector such that a gap is formed between the support ring and the heating surface. The heat distributing plate support ring may be sized and shaped to rest on the flat base between the inner catchment rim and the side wall. The heating surface may be convex shaped when viewed from above, and be sized and shaped so that all points on its perimeter protrude outward beyond the inner catchment rim surrounding the hole in the flat base plate.

A grill plate may be positioned above the heat distributing convection plate. In a preferred embodiment, the grill plate may, for instance, be a substantially flat grill plate and have a plurality of grill plate holes. The grill plate may be used to support food during the cooking process. The grill plate may also have at least one grill plate handle. The grill plate may be shaped and sized to rest on a horizontal lip protruding from the wall of the base such that it may be positioned above a top of the convection surface.

In a preferred embodiment, a lid having a centrally located top may also have a horizontally protruding lid lip that may be shaped and sized to rest on the grill plate, or on an upper, protruding lip of the wall of the base structure.

Therefore, the present invention succeeds in conferring the following, and others not mentioned, desirable and useful benefits and objectives.

It is an object of the present invention to provide a portable cooking utensil with a flow of air that produces the advantages of a convection oven without the use of an electric fan.

It is another object of the present invention to provide stove top cooking utensil that produces the advantages of a convection oven.

Yet another object of the present invention is to provide a convection oven that can be used outdoors by campers.

Still another object of the present invention is to provide a passive, convection oven that can uniformly heat the surface of food that is being cooked in it.

Still another object of the present invention is to provide a passive, convection oven that is simple to use.

It is an object of the present invention to provide a portable, passive-convection cooking oven, comprising a base structure comprising a substantially flat base having circular centered hole shaped and sized to fit a domestic stove gas burner or electric heating ring, and having a substantially upwardly oriented side wall, contiguous with, and running along the entire perimeter of said substantially flat base and said upwardly oriented side wall having at least one horizontally protruding base lip and at least one base handle attached to said upwardly oriented side wall; and an upwardly protruding, inner catchment rim running along the entire perimeter of said circular hole; a heat distributing convection plate having a heat distributing plate support ring, at least one elevating connector, connected at its first end to said convection plate support ring and at its second end to a substantially convex heating surface, said elevating connector being shaped and sized to maintain said substantially convex convection surface above said heat distributing plate support ring such that a fluidly connecting gap is formed between said heat distributing plate support ring and said substantially convex heating surface and where said heat distributing plate support ring is sized and shaped to rest on said substantially flat base between said upwardly protruding inner catchment rim and said upwardly oriented side wall and wherein all points on the perimeter of said substantially convex convection surface protrude outward beyond said upwardly protruding, inner catchment rim; a substantially flat grill plate, with a plurality of grill plate holes and at least one grill plate handle, said substantially flat grill plate being shaped and sized to rest on said horizontally protruding base lip above a top of said substantially convex convection surface; and a substantially convex lid having a centrally located top handle, said substantially convex lid having a horizontally protruding lid lip shaped and sized to rest either on said substantially flat grill plate or on said base structure.

### BRIEF DESCRIPTION OF THE DRAWINGS

FIG. 1 shows an isometric top view of a portable, passive-convection cooking oven in accordance with a preferred embodiment of the present invention.

FIG. 2 shows an exploded, isometric view of a portable, passive-convection cooking oven in accordance with a preferred embodiment of the present invention.

FIG. 3 shows a schematic cross-section view the base structure and the heat distributing convention plate of a portable, passive-convection cooking oven in accordance with a preferred embodiment of the present invention.

FIG. 4 shows an isometric top view of the base structure and the heat distributing convention plate of a portable, passive-convection cooking oven in accordance with a further preferred embodiment of the present invention.

FIG. 5 shows an isometric top view of the base structure and the heat distributing convention plate of a portable, passive-convection cooking oven in accordance with yet another preferred embodiment of the present invention.

FIG. 6 shows an isometric top view of the heat distributing convention plate of a portable, passive-convection cooking oven in accordance with a further preferred embodiment of the present invention having both wedge shaped convex corrugations and wedge shaped flat surfaces.

FIG. 7 shows an isometric top view of the base structure and the heat distributing convention plate of a portable, passive-convection cooking oven in accordance with yet a further preferred embodiment of the present invention.

FIG. 8 shows a schematic cross-section view the base structure and the heat distributing convention plate of a portable, passive-convection cooking oven in accordance with yet a further preferred embodiment of the present invention.

FIG. 9 shows a schematic plan view of the base structure and the heat distributing convention plate of a portable, passive-convection cooking oven in accordance with yet a further preferred embodiment of the present invention.

FIG. 10 shows an isometric top view of a substantially square base structure, the heat distributing convention plate and the wire grill structure of a portable, passive-convection cooking oven in accordance with one more preferred embodiment of the present invention.

FIG. 11 shows an isometric top view of the base structure and the heat distributing convention plate of a portable, passive-convection cooking oven in accordance with yet a further embodiment of the present invention.

FIG. 12 shows an isometric top view of the base structure and the heat distributing convention plate of a portable, passive-convection cooking oven in accordance with another embodiment of the present invention.

FIG. 13 shows an isometric top view of a portable, passive-convection cooking oven having thermometer, in accordance with yet a further embodiment of the present invention.

FIG. 14 shows a top view of a portable, passive-convection cooking oven having thermometer, in accordance with yet a further embodiment of the present invention.

FIG. 15 shows a top view of a grill paddle for a substantially square or rectangular shaped portable, passive-convection cooking oven of this invention.

FIG. 16 shows a side view of a substantially square or rectangular shaped portable, passive-convection cooking oven of this invention.

FIG. 17 shows a top, isometric view of a lid having a handle incorporating a thermometer suitable for a portable, passive-convection cooking oven of this invention.

FIG. 18 shows a top, isometric view of a lid having a handle incorporating a thermometer suitable and side vent slits suitable for a portable, passive-convection cooking oven of this invention.

FIG. 19 shows a bottom, isometric view of a lid having indented holding grips, suitable for a portable, passive-convection cooking oven of this invention.

FIG. 20 shows a top, isometric view of a lid handle incorporating a thermometer, suitable for a portable, passive-convection cooking oven of this invention.

FIG. 21 shows a schematic plan view of the base structure and the heat distributing convention plate of a portable, passive-convection cooking oven in accordance with a further preferred embodiment of the present invention.

FIGS. 22 A and B shows a schematic view of the flat grill plate in accordance with a further preferred embodiment of the present invention.

FIG. 23 shows a schematic view of the grill plate rim and the grill plate in accordance with a further preferred embodiment of the present invention

FIG. 24 shows a schematic view of the grill plate in accordance of another preferred embodiment of the present invention.

FIG. 25. shows a schematic view of the grill plate in accordance of yet anther preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto without exceeding the scope of the present inventive concepts.

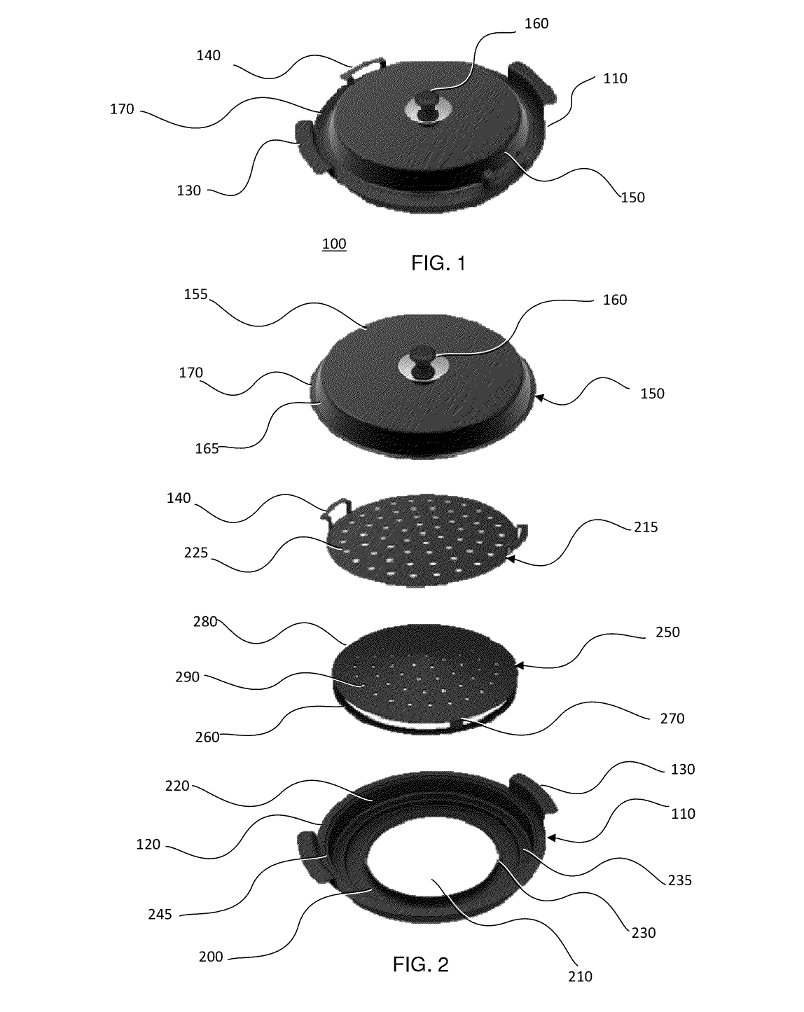

FIG. 1 shows an isometric top view of a portable, passive-convection cooking oven in accordance with a preferred embodiment of the present invention.

In a preferred embodiment, the portable, passive-convection cooking oven 100 may have a base structure 110 that may have at least one base handle 130 attached to it. On top of the base structure 110 may be a removable, substantially convex lid 150. The lid 150 may have a horizontally protruding lid lip 170 that may allow it to rest on top of the base structure 110. The lid 150 may also have a centrally located top handle 160. Also shown in FIG. 1 is a grill plate handle 140.

FIG. 2 shows an exploded, isometric view of a portable, passive-convection cooking oven in accordance with a preferred embodiment of the present invention.

The portable, passive-convection cooking oven 100 may be comprised of four parts.

A first part may be the base structure 110. In a preferred embodiment, the base structure 110 may include a substantially flat base 200 having an approximately centered hole 210 and a base handle 130. The hole 210 is preferably shaped and sized to fit a standard, domestic stove, or oven, gas burner or electric heating ring. Although the hole may be circular in a preferred embodiment, one of ordinary skill in the art will readily appreciate that the hole may be of any suitable shape such as, but not limited to, an oval, a rectangle, a cookie cup type outline, or some combination thereof.

In a preferred embodiment, the hole may be shaped and sized to fit on top of standard, domestic stove, or oven, gas burner or electric heating element. The hole may, however, also, or instead, be designed to fit over a standard, domestic stove heating element and rest on the stove top. As domestic stove heating elements typically range in diameter from range in size from 6 to 8 inches in diameter, the hole of this invention may preferably have a diameter in, but not limited to, a range from 3 to 9 inches.

The base structure 110 may also have an inner catchment rim 230 that protrudes upwards and is seamlessly made part of the base 200 and runs the entire perimeter of the circular hole 210. The upwardly protruding, inner catchment rim 230 may serve to, but is not limited to, prevent any liquid falling through the circular hole 210 on to an oven burner or gas heating element.

In a preferred embodiment, the base structure 110 may also have an upwardly oriented, side wall 220 that may be, but is not limited to, be substantially vertical. The base structure 110 may also include a lower horizontal base lip 235, an upper horizontal base lip 245 and a horizontally protruding base lip 120. The horizontally protruding base lip 120 may, for instance, serve to support the substantially convex lid 150. The horizontally protruding base lip 120 may, therefore, be shaped and sized to match the horizontally protruding lid lip 170 of the lid 150.

The upper horizontal base lip 245 may, for instance, serve to support the substantially flat grill plate 215 and may, therefore, be shaped and sized to match a perimeter of the substantially flat grill plate 215.

A second part may be the heat distributing convection plate 250. In a preferred embodiment, the heat distributing convection plate 250 may include a substantially convex heating surface 280 with convection openings 290, a heat distributing plate support ring 260 and one or more elevating connectors 270. The elevating connector 270 may, for instance, be serve to locate the substantially convex heating surface 280 over the circular hole 210 in the base structure 110. The heat distributing plate support ring 260 may be sized and shaped to rest on the substantially flat, base 200 between the upwardly protruding, inner catchment rim 230 and the inside perimeter of the lower horizontal base lip 235 of the base structure 110.

The elevating connector 270 may, at one of its ends, rigidly attach to the heat distributing plate support ring 260, and at the other end, rigidly attach to the substantially convex heating surface 280. This attachment may be such that gaps are created between the periphery of the heating surface 280 and the top of the support ring 260. These gaps may allow air heated by a source of heat located in a vicinity of the circular hole 210 such as, but not limited to, an oven gas ring, an electric heating plate, a log fire, a camping gas ring, or some combination thereof, to circulate up over the top of the substantially convex heating surface 280, up to and through the substantially flat grill plate 215 and into the space between the substantially flat grill plate 215 and the inside of the substantially convex lid 150. The heat distributing convection plate 250 may also include convection openings 290 in the substantially convex heating surface 280. These convection openings 290 may have upwardly projecting peripheries that may, for instance, be made by a technique such as, but not limited to, punching the holes up from below. The convection openings 290 may further aid the heated air to circulate up from the heat source located in a vicinity of the circular hole 210 to the space between the substantially flat grill plate 215 and the inside of the substantially convex lid 150 where one or more items to be heated or cooked may be residing.

The substantially convex heating surface 280 may have a shape that slopes down to its periphery such as, but not limited to, a cone having a downward slope of less than 30 degrees, or, in a more preferred embodiment, less than 15 degrees.

The substantially convex heating surface 280 is preferably sized such that all points on its periphery extend beyond that upwardly protruding, inner catchment rim 230 of the base structure 110 when the portable, passive-convection cooking oven 100 is assembled. In that way, any liquid dripping down from the substantially flat grill plate 215 may be directed to fall into the channel on the substantially flat, base 200, the upwardly protruding, inner catchment rim 230 and the lower horizontal base lip 235 or the side wall 220.

A third part may be a substantially flat grill plate 215. The substantially flat grill plate 215 may be shaped and sized to fit onto, and be supported by, the upper horizontal base lip 245 of the base structure 110. In a preferred embodiment, the substantially flat grill plate 215 may have one or more grill plate holes 225 and preferably one or more grill plate handles 140. The grill plate holes 225 may allow heated air to circulate up through the substantially flat grill plate 215, while the grill plate 215 supports one or more items to be heated or cooked. The one or more grill plate handle 140 may serve to place and remove the substantially flat grill plate 215 on the upper horizontal base lip 245 of the base structure 110.

A fourth part may be the substantially convex lid 150. The lid 150 may have a lid upper surface 155 that may be substantially flat. The lid upper surface 155 may be joined to a lid side wall 165 to form a contiguous whole. The lid side wall 165 may also be joined at its lower periphery to a horizontally protruding lid lip 170. The substantially convex lid 150 may also have a centrally located top handle 160.

The parts that may make up the portable, passive-convection cooking oven 100, i.e., the base structure 110, the heat distributing convection plate 250, the substantially flat grill plate 215 and the substantially convex lid 150 may be made of any suitable material, or combination of materials, or materials and coatings that maintain their structural integrity at a temperature of at least 500 degrees Fahrenheit. Suitable materials include, but are not limited to, metal, metal alloys, anodized aluminum, aluminum with/or without an interior and/or an exterior lining of stainless steel, carbon steel, enameled carbon steel, stainless steel, cast iron, enameled cast iron, copper, copper with an interior and/or an exterior lining of stainless steel, a suitable glass, a suitable ceramic, alumina, mullite, silicon carbide or some combination thereof.

The parts may be coated, or otherwise treated, with a suitable material or coating to modify on or more functional or aesthetic surface characteristics such as, but not limited to, a color of the surface, a texture of the surface, a washablity or cleaning characteristics of the surface, the corrosion characteristics of a surface, the non-stick property of a surface or some combination thereof. For instance, coatings to make the surface a non-stick surface may include, but are not limited to, Teflon™ a.k.a. polytetrafluoroethylene (PTFE), perfluoroalkoxy (PFA), fluorinated ethylene propylene (FEP), ethylene tetrafluoroethylene (ETFE) or some combination thereof. Coatings to affect the color of a surface may include, but are not limited to, ceramic coatings, silicone coats such as, but not limited to, methyl polysiloxane, phenyl polysiloxane, or methyl phenyl polysiloxane, with or without suitable high temperature stable pigments such as, but not limited to, zinc oxide (white), cadmium sulfide (yellow/orange), cobalt (blue), titanium dioxide (white), iron oxide (red), copper salts (green) or some combination thereof.

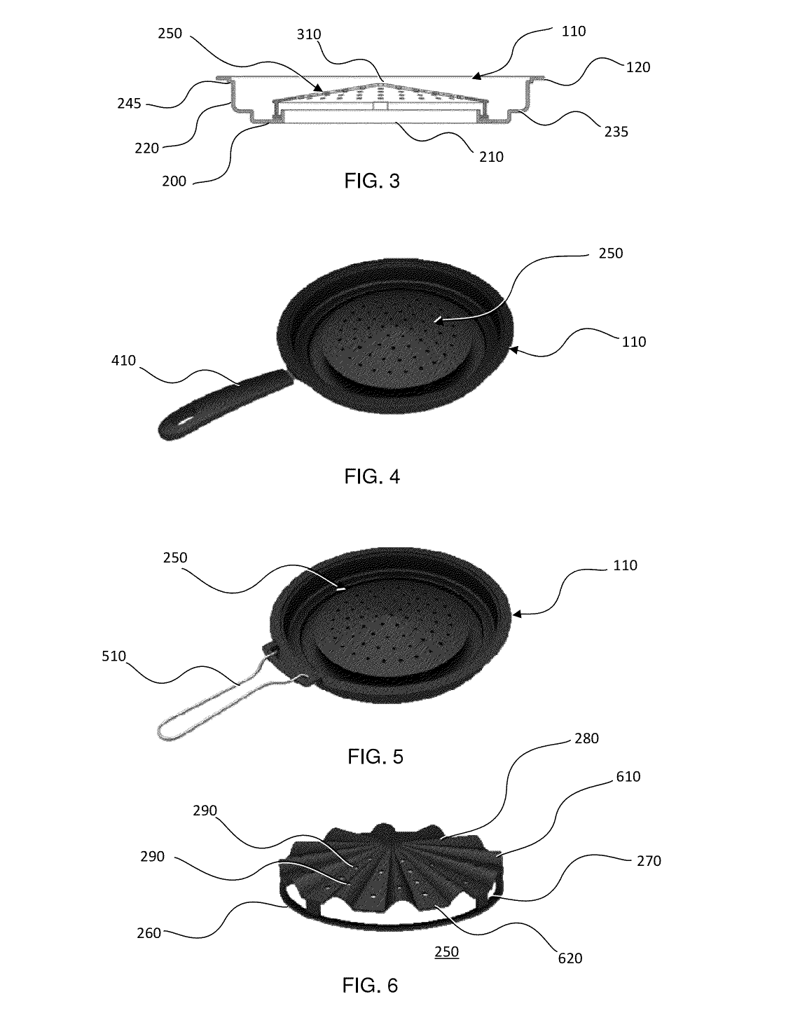

FIG. 3 shows a schematic cross-section view the base structure and the heat distributing convention plate of a portable, passive-convection cooking oven in accordance with a preferred embodiment of the present invention.

FIG. 3 shows a heat distributing convection plate 250 that is conical in shape. One of ordinary skill in the art will readily appreciate that the heat distributing convection plate 250 may have any suitable surface that slopes down from the centrally located apex 310, i.e., is substantially convex when viewed from above, such as, but not limited to, a portion of a sphere, a portion of a rotated conic section or some combination thereof.

The heat distributing convection plate 250 may be shaped and sized to rest on the substantially flat, base 200 such that it completely covers the circular hole 210 in the base of the base structure 110. The portable, passive-convection cooking oven 100 may also have an upwardly oriented, side wall 220 with a lower horizontal base lip 235 an upper horizontal base lip 245 and a horizontally protruding base lip 120.

FIG. 4 shows an isometric top view of the base structure and the heat distributing convention plate of a portable, passive-convection cooking oven in accordance with a further preferred embodiment of the present invention. A heat distributing convection plate 250 is shown in place in a base structure 110. In this embodiment, the base structure 110 may have one single hand, extended substantially solid handle 410.

FIG. 5 shows an isometric top view of the base structure and the heat distributing convention plate of a portable, passive-convection cooking oven in accordance with yet another preferred embodiment of the present invention. Once again the heat distributing convection plate 250 is shown in place in the base structure 110. In this embodiment, the base structure 110 may have one single hand, extended wire-loop handle 510.

FIG. 6 shows an isometric top view of the heat distributing convention plate of a portable, passive-convection cooking oven in accordance with a further preferred embodiment of the present invention having both wedge shaped convex corrugations and wedge shaped flat surfaces.

In this embodiment, the heat distributing convection plate 250 may have a heat distributing plate support ring 260 connected to one or more elevating connector 270 that support a substantially convex heating surface 280. The substantially convex heating surface 280 may, however, consist of one or more of wedge shaped convex corrugations 610 separated by one or more wedge shaped flat surfaces 620. Either the of wedge shaped convex corrugations 610 or the wedge shaped flat surfaces 620, or both, may have one or more convection openings 290. These convection openings 290 may have upwardly protruding rims.

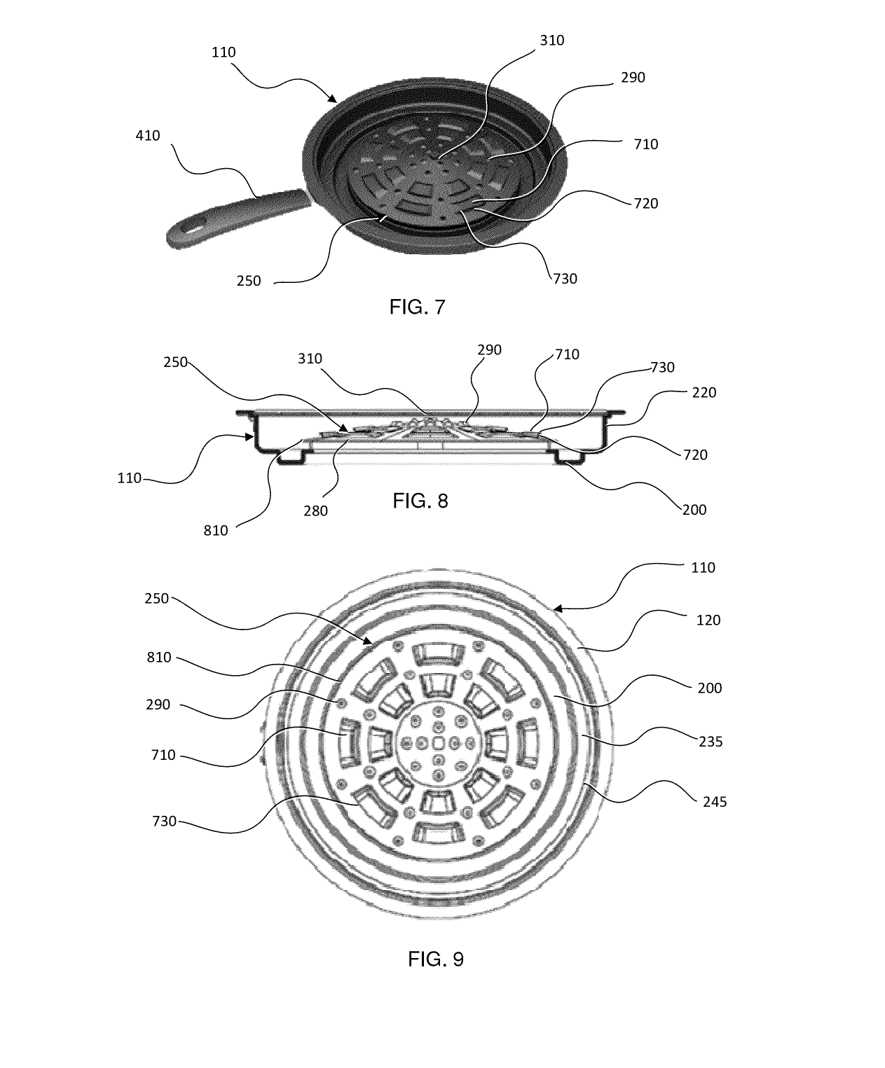

FIG. 7 shows an isometric top view of the base structure and the heat distributing convention plate of a portable, passive-convection cooking oven in accordance with yet a further preferred embodiment of the present invention.

FIG. 7 shows a heat distributing convection plate 250 in place in a base structure 110 that may have one single hand, extended substantially solid handle 410. The heat distributing convection plate 250 may have a centrally located apex 310 and may include one or more substantially rectangular shaped surfaces 710 having a slit shaped opening 720 at a radial rectangle side 730, i.e., the portion of the substantially rectangular shaped surfaces 710 furthest from the centrally located apex 310. The slit shaped opening 720 may serve to allow heated air to be convected up through the convection openings 290 in the heat distributing convection plate 250.

FIG. 8 shows a schematic cross-section view the base structure and the heat distributing convention plate of a portable, passive-convection cooking oven in accordance with yet a further preferred embodiment of the present invention.

The heat distributing convection plate 250 is shown resting on the base structure 110. The base structure 110 may have a substantially flat, base 200 and an upwardly oriented side wall 220 that may be, but is not limited to being, substantially vertical. The heat distributing convection plate 250 may have a centrally located apex 310 from which it slopes down toward a perimeter 810 of said substantially convex convection surface 280. The substantially convex heating surface 280 may also contain one or more convection openings 290 that are through holes with upwardly projecting rims. The upwardly projecting rims may, for instance, serve to prevent liquids falling from grill plate above from falling through to the heat source below.

As shown in cross-section in FIG. 8, the heating surface 280 may also contain one or more slit shaped openings 720 that may, for instance, be formed at a radial rectangle side 730 of a substantially rectangular shaped surfaces 710, i.e., a portion of the heating surface 280 may be shaped to have a slit shaped opening 720 in which a rectangular or trapezoidal shaped section is effectively bent upward so that the slit occurs on the side of the bent section furthest from the centrally located apex 310, while the rest of the rectangular or trapezoidal shaped section remains in sealed contact with the substantially convex heating surface 280. A slit shaped like this may, for instance, serve to allow heated air to circulate through the heat distributing convection plate 250 while preventing downward dripping liquid to fall through to a heat source beneath the base structure 110.

FIG. 9 shows a schematic plan view the base structure and the heat distributing convention plate of a portable, passive-convection cooking oven in accordance with yet a further preferred embodiment of the present invention.

FIG. 9 also shows the perimeter 810 of convection surface 280, and the horizontally protruding base lip 120, the lower horizontal base lip 235 and the upper horizontal base lip 245 of the base structure 110, the convection holes 290, as well as structures labeled in FIG. 8 above.

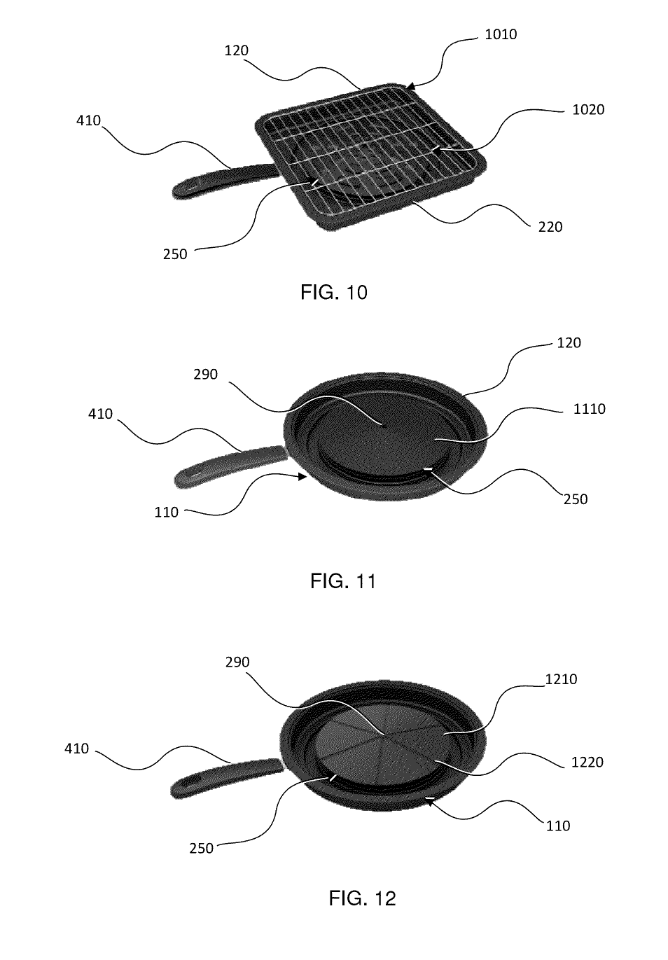

FIG. 10 shows an isometric, top view of a substantially flat, square, metallic or ceramic base structure 1010, the heat distributing convention plate 250 and a substantially flat wire mesh grill structure 1020 of a portable, passive-convection cooking oven in accordance with one more preferred embodiment of the present invention. According to one preferred embodiment, the flat wire mesh grill structure may be replaced by a flat solid structure. The flat solid structure, as well as the wire mesh grill structure may have handles to lift it off the base structure.

The substantially flat, square, metallic or ceramic base structure 1010 may include a horizontally protruding base lip 120 and an upwardly oriented side wall 220. A single extended substantially solid handle 410 may also be attached to the square base structure 1010.

FIG. 11 shows an isometric top view of the base structure 110 and the heat distributing convention plate 250 and horizontally protruding base lip 120 of a portable, passive-convection cooking oven in accordance with yet a further embodiment of the present invention.

In this embodiment, the heat distributing convection plate 250 may have a substantially conical, convex convection surface 1110. The substantially conical, convex convection surface 1110 may, for instance, have a single convection opening 290 that may be located at the top of the substantially conical, convex convection surface 1110.

In this embodiment, as in all embodiments of the portable, passive-convection cooking oven 100, a handle such as, but not limited to, a single extended substantially solid handle 410, or any of the other handle types and shapes described or illustrated in this application, may be attached to the base structure 110.

FIG. 12 shows an isometric top view of the base structure 110 and the heat distributing convention plate 250 of a portable, passive-convection cooking oven in accordance with another embodiment of the present invention.

In this embodiment, the heat distributing convection plate 250 may be formed, in part, of one or more metallic or ceramic, wedge shaped sections of a cone 1210. The metallic or ceramic, wedge shaped sections of a cone 1210 may be joined to each other by one or more linear, concave conduits 1220. The heat distributing convection plate 250 may have one or more substantially centrally located convection openings 290. Also shown is a single extended substantially solid handle 410.

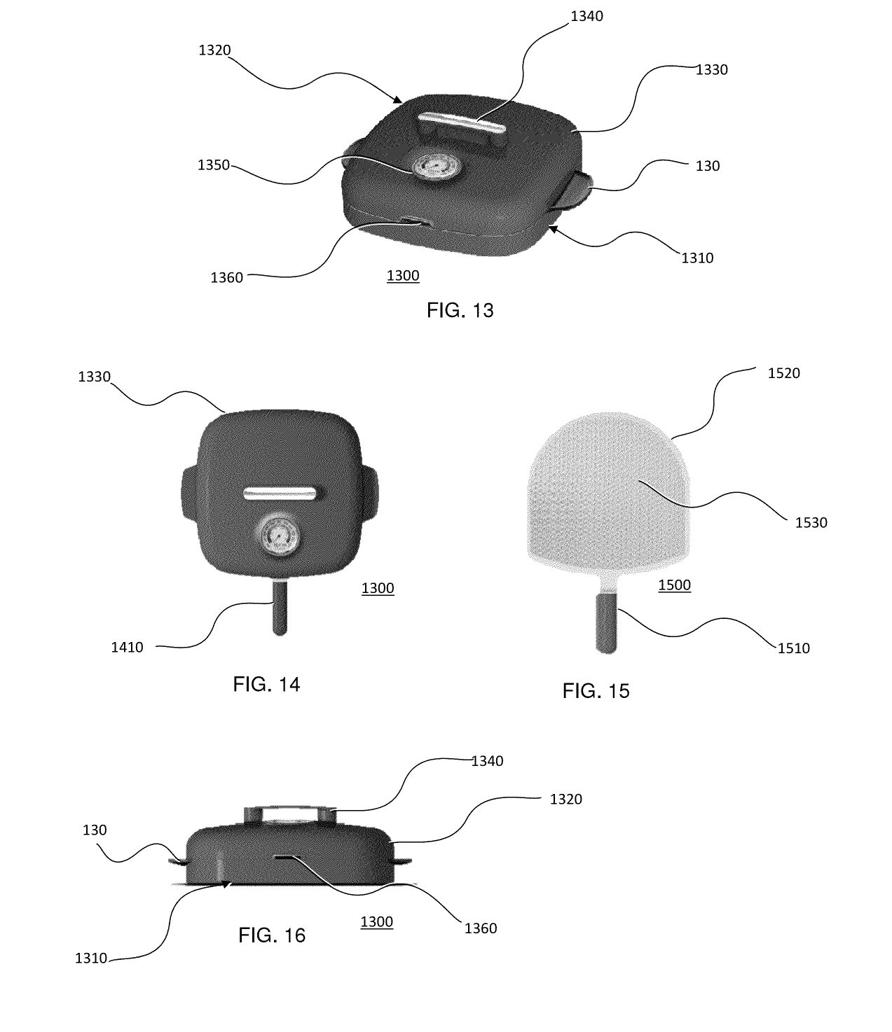

FIG. 13 shows an isometric top view of a substantially square or rectangular shaped portable, passive-convection cooking oven 1300 having a domed lid 1320 with a curved side of the domed lid 1330, and having a temperature thermometer 1350, in accordance with yet a further embodiment of the present invention.

The substantially square or rectangular passive-convection cooking oven 1300 may, for instance, have a bow shaped handle 1340 attached to an upper surface of the substantially square, or rectangular, domed lid 1320. The temperature thermometer 1350 may also be attached to the upper surface of the substantially square or rectangular shaped, domed lid 1320. The temperature thermometer 1350 may be of any suitable type for measuring temperatures in the general cooking range of about 150 to 550 degrees Fahrenheit. The temperature thermometer 1350 may, for instance, have a heat sensor such as, but not limited to, a bimetallic sensor or a liquid or gas filled sensor, or a vapor-tension based sensor, or some combination thereof.

The substantially square or rectangular shaped, domed lid 1320 may, for instance, fit onto a substantially square or rectangular shaped, base structure 1310, the two items having been sized and shaped to be a matching fit to each other. The base structure 1310 may have one or more short, base handles 130 attached to its sides.

There may also be an opening in the lower portion of the domed lid for a grill paddle handle 1360. This opening may, for instance, allow the domed lid 1320 to fit onto the base structure 1310 in such a way that there is a seal between the two items at all points on a periphery of one of them, except in a vicinity of the opening 1360. The opening 1360 may, when assembled form a seal with a portion of a handle of the grill paddle.

FIG. 14 shows a top view of a portable, passive-convection cooking oven 1300 having a thermometer, in accordance with yet a further embodiment of the present invention. Also shown in FIG. 14 are a grill paddle handle 1410 and a curved side of the domed lid 1330.

FIG. 15 shows a top view of a grill paddle 1500 suitable for a passive-convection cooking oven of this invention. The grill paddle 1500 shown in FIG. 15 may be particularly suited by its shape to fit a substantially square or rectangular shaped portable, passive-convection cooking oven 1300. The grill paddle 1500 may, for instance, have a grill paddle handle 1510 that may be rigidly attached to a grill paddle structural edge 1520. The grill paddle structural edge 1520 may be shaped and sized, in part, to be a fit to the interior of the substantially square or rectangular shaped portable, passive-convection cooking oven 1300. The grill paddle structural edge 1520 may contain a grill paddle support grid 1530. The grill paddle support grid 1530 may be designed to support items to be heated or cooked, while allowing heated air to be convected through the grid to assist in the heating of items on the grill paddle 1500.

FIG. 16 shows a side view of a substantially square or rectangular shaped portable, passive-convection cooking oven 1300 of this invention. FIG. 16 shows the bow shaped handle 1340 that may be attached to an upper region of the substantially square or rectangular shaped, domed lid 1320. Also shown is the opening in domed lid for grill paddle handle 1360 that may be located on a lower edge of the substantially square or rectangular shaped, domed lid 1320. The substantially square or rectangular shaped, domed lid 1320 may rest on, and form a substantially air tight seal with the substantially square or rectangular shaped, base structure 1310. The substantially square or rectangular shaped, domed lid 1320 may have at least one short base handle 130 rigidly attached to it on an upper portion of the side wall.

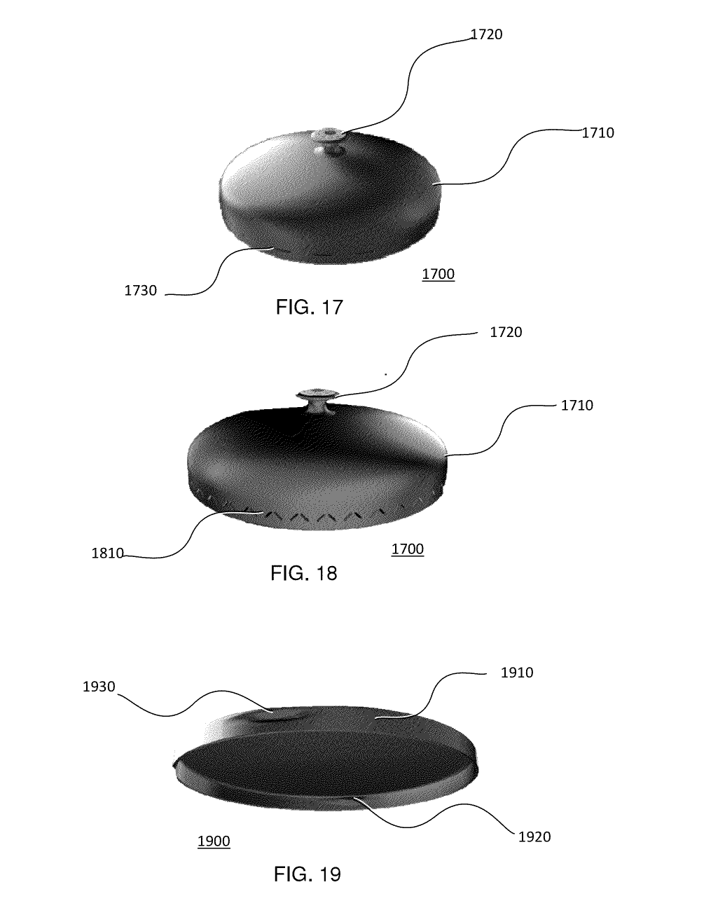

FIG. 17 shows a top, isometric view of a dome shaped lid 1700 having a knob shaped lid handle with an integral thermometer 1720 knob, suitable for a portable, passive-convection cooking oven of this invention.

The dome shaped lid 1700 may have a curved, upper surface of dome shaped lid 1710. The dome shaped lid 1700 may also have one or more side-wall slits 1730 located near a base of the dome shaped lid 1710. These side-wall slits 1730 may allow some of the hot air or steam to vent out from the pan. This may, for instance, help prevent too much pressure building up underneath the lid when the oven is being used.

FIG. 18 shows a top, isometric view of dome shaped lid 1700 having a curved upper surface 1710, a lid handle 1720 with integral thermometer and one or more chevron-patterned side-wall slits 1810 located in a vicinity of the base of the dome shaped lid 1810. The chevron-patterned side wall slits 1810 may be either decorative or functional, as described above, or both.

FIG. 19 shows a bottom, isometric view of a lid 1900 with one or more handling indents, or indented holding grips. The lid 1900 may have a side wall of lid that contains the handling indents 1910. The handling indents may be formed such that, viewed from the inside, they may form inner, convex surface of the handling indent 1920 while viewed from the outside they may form a concave surface of handling indent 1930. Such indents may, for instance, reduce the manufacturing costs of the lid.

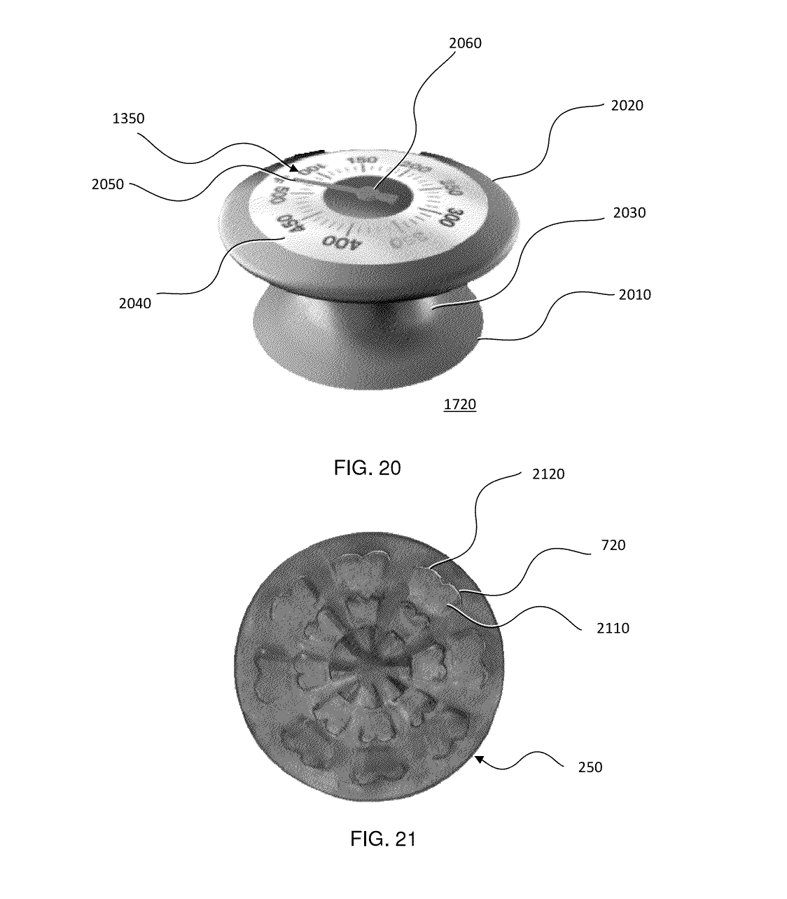

FIG. 20 shows a top, isometric view of a lid handle 1720 incorporating a thermometer 1350. The lid handle 1720 may include a lower end 2010 and an upper end 2020.

The lower end 2010 of the integrated thermometer and lid handle may, for instance, be rigidly or removably attached to a lid. The upper end of lid handle 2020 may be separated from the lower end 2010 by a waist region 2030. The waist portion 2030 of the integrated thermometer and lid handle may, for instance, be functional to facilitate a good grip on the handle.

The temperature thermometer 1350 may include a thermometer scale 2040, a thermometer indicator needle 2050 and a thermometer indicator needle pivot 2060.

The thermometer indicator needle pivot 2060 may, for instance, be connected to a heat sensor (not shown) that may be a sensor suitable for measuring temperatures in a range such as, but not limited to, a range of 250 to 550 degrees Fahrenheit. This may, for instance, be a heat sensor such as, but not limited to, bimetal sensor, a liquid or gas filled sensor, or a vapor-tension-based sensor or some combination thereof. The thermometer scale 2040 may be graduated in a suitable scale such as, but not limited to, degrees Fahrenheit or degrees Celsius or some combination thereof. During use, the thermometer indicator needle 2050 may, for instance, move under the influence of the heat sensor acting through the thermometer indicator needle pivot 2060 so as to indicate a temperature measure in or near the inside of the portable, passive-convection cooking oven.

FIG. 21 shows a schematic plan view of the base structure and the heat distributing convention plate of a portable, passive-convection cooking oven in accordance with a further preferred embodiment of the present invention.

As shown in FIG. 21, this embodiment of the heat distributing convection plate 250 may include one or more slit shaped opening 720. As shown in FIG. 21, these slit shaped opening 720 may be formed by an upwardly pressed surface 2110 that may have a scalloped or heart shaped outer edge 2120.

As shown in FIG. 21, the heat distributing convection plate 250 may have no convention openings 290 having upwardly protruding rims, as shown previously in, for instance, FIG. 9.

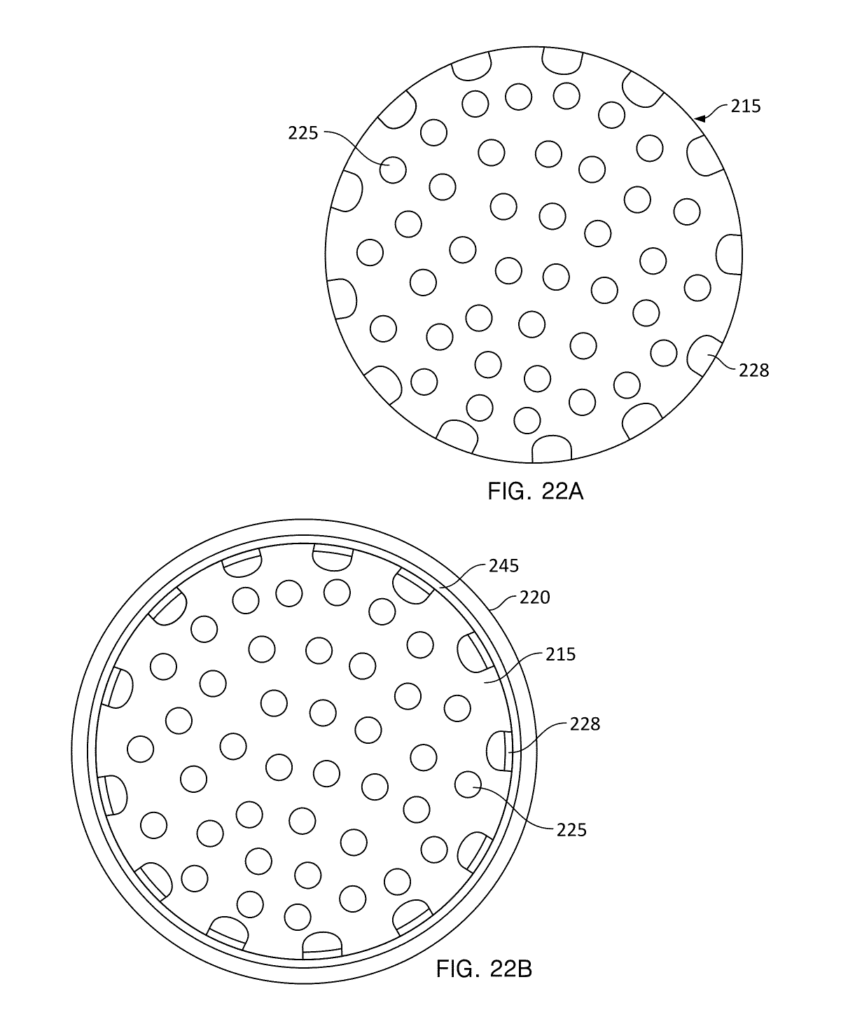

One way to use the convection oven of this invention is to make pizza pie. When the pizza crust is very large it may however, happen that all the grill plate holes will be covered by the pizza crust and this would impair air circulation in the oven. Solutions to this problem are provided by various designs of the grill plate shown in FIGS. 22-25.

FIG. 22 A shows a preferred embodiment where on the grill plate 215 there are additional openings 228 along the perimeter of the plate. FIG. 22B shows the grill plate 215 on its place resting on the upper horizontal base lip 245. The openings 228 are so designed that their diameter is larger than the width of the upper horizontal base lip so that the air can flow through the part of the opening that is not resting on the base lip.

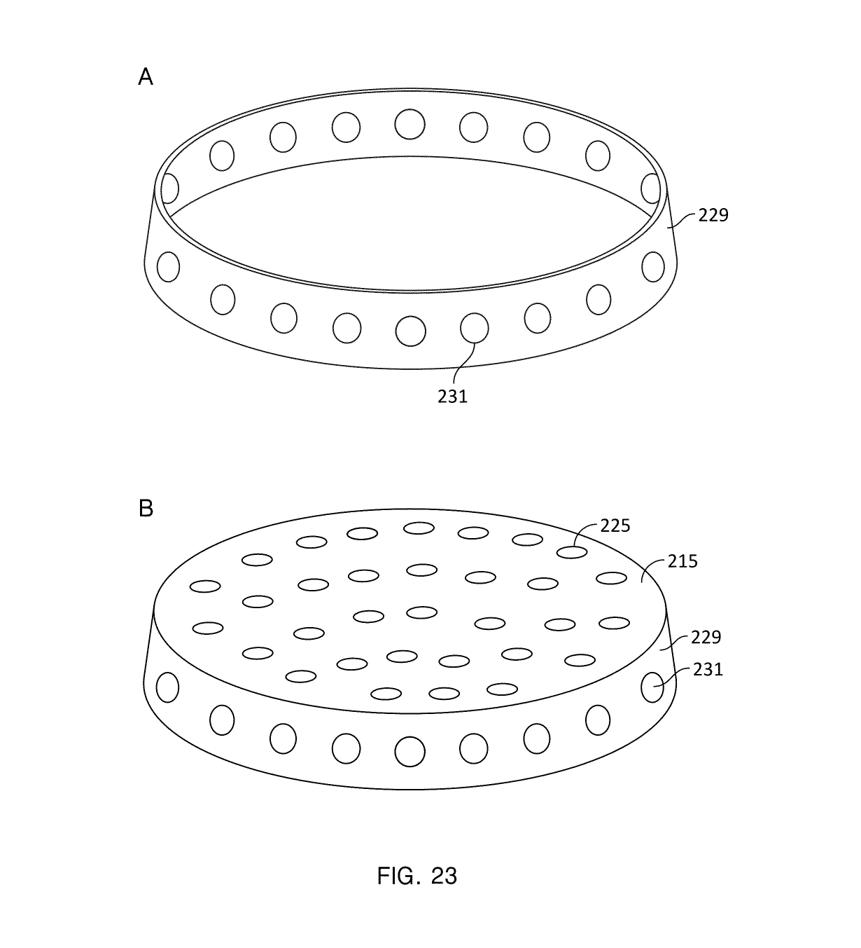

FIGS. 23A and B shows another preferred embodiment to solve the problem of the plate holes becoming covered with a pizza crust. FIG. 23A shows a grill plate rim 229 that has diameter such that it rests on the upper horizontal base lip 245. The grill plate rim 229 has ventilation holes 231 that allow air flow even when the grill plate 215 would be so covered by a crust that the grill plate holes 225 were all covered. FIG. 23B shows the grill plate 215 on top of the rim 229. The height of the rim is in range of ⅛ to ¼ inches.

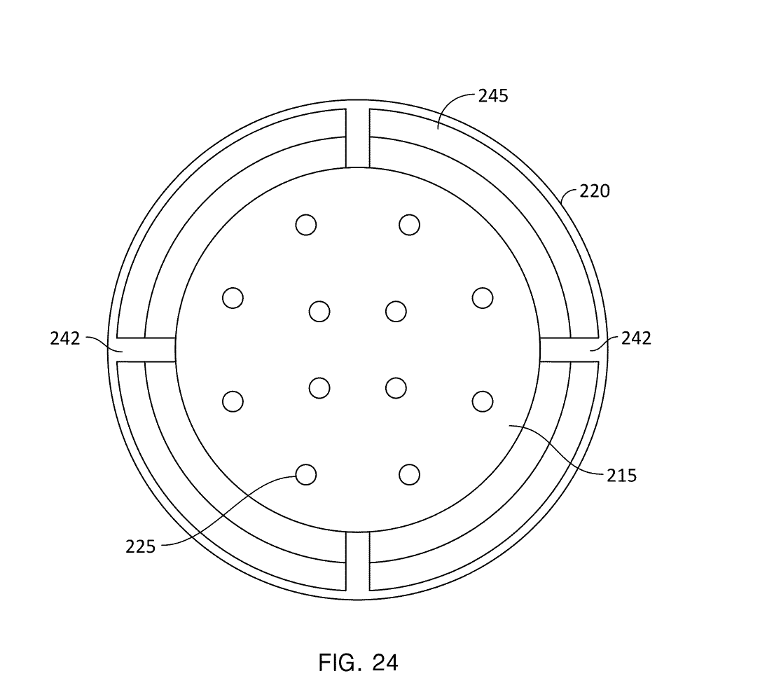

FIG. 24 provides yet another preferred embodiment where the grill plate 215 has a diameter smaller than the diameter of the area surrounded by the upper horizontal base lip 245. According to this embodiment the grill plate 215 has horizontally projecting legs 242 that rest on the upper horizontal base lip 245 whereby the air can circulate through the space that is between the base lip and the grill plate. According to yet another preferred embodiment the legs 242 may project diagonally downward thereby lifting the grill plate upward.

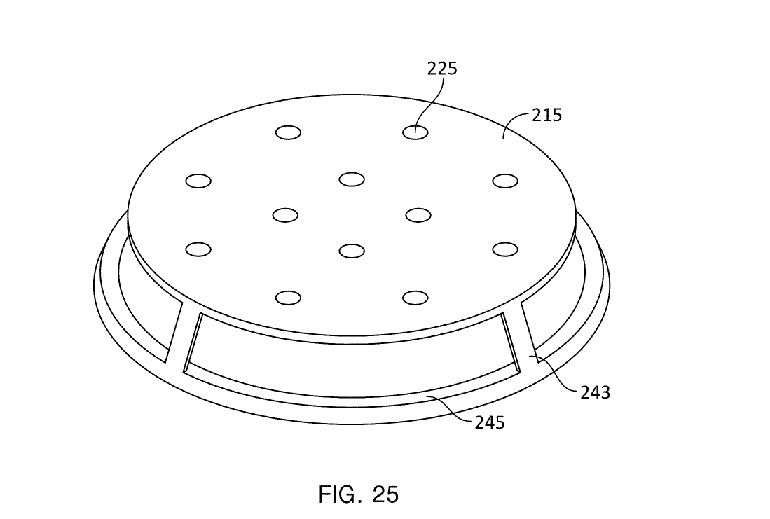

As is shown in FIG. 25, according to yet another embodiment the grill plate 215 stands on vertical legs 243. In this embodiment the grill plate has diameter that is such that the vertical legs will rest on the upper horizontal base lip 245.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A portable, passive-convection cooking oven, comprising:
a base structure comprising a substantially flat base having circular centered hole shaped and sized to fit a domestic stove gas burner or electric heating ring, and having a substantially upwardly oriented side wall, contiguous with, and running along the entire perimeter of said substantially flat base and said upwardly oriented side wall having at least one horizontally protruding base lip and at least one base handle attached to said upwardly oriented side wall; and an upwardly protruding, inner catchment rim running along the entire perimeter of said circular hole;
a heat distributing convection plate having a heat distributing plate support ring, at least one elevating connector, connected at its first end to said convection plate support ring and at its second end to a substantially convex heating surface, said elevating connector being shaped and sized to maintain said substantially convex convection surface above said heat distributing plate support ring such that a fluidly connecting gap is formed between said heat distributing plate support ring and said substantially convex heating surface and where said heat distributing plate support ring is sized and shaped to rest on said substantially flat base between said upwardly protruding inner catchment rim and said upwardly oriented side wall and wherein all points on the perimeter of said substantially convex convection surface protrude outward beyond said upwardly protruding, inner catchment rim;
a substantially flat grill plate, with a plurality of grill plate holes and at least one grill plate handle, said substantially flat grill plate being shaped and sized to rest on said horizontally protruding base lip above a top of said substantially convex convection surface; and
a substantially convex lid having a centrally located top handle, said substantially convex lid having a horizontally protruding lid lip shaped and sized to rest either on said substantially flat grill plate or on said base structure.

2: The portable, passive-convection cooking oven of claim 1, wherein said substantially convex heating surface of said heat distributing convection plate further comprises a plurality of convection openings having upwardly projecting peripheres.

3: The portable, passive-convection cooking oven of claim 1, wherein said upwardly oriented side wall of said base structure further comprises a lower horizontal base lip and an upper horizontal base lip shaped and sized to fit and support said substantially flat grill plate.

4: The portable, passive-convection cooking oven of claim 3, wherein said heat distributing convection plate is conical in shape and has a centrally located apex.

5: The portable, passive-convection cooking oven of claim 1, wherein said base handle is a single substantially solid extended handle.

6: The portable, passive-convection cooking oven of claim 1, wherein said base handle is a single extended wire-loop handle.

7: The portable, passive-convection cooking oven of claim 1, wherein said substantially convex heating surface of said heat distributing convection plate comprises a plurality of wedge shaped convex corrugations alternating with a plurality of wedge shaped flat surfaces.

8: The portable, passive-convection cooking oven of claim 1, wherein said substantially convex heating surface of said heat distributing convection plate comprises a plurality of substantially rectangular shaped surfaces sloped at a lower angle than said substantially convex heating surface and having a slit shaped opening at a radial rectangle side situated farthest from said centrally located apex of said heat distributing convection plate.

9: The portable, passive-convection cooking oven of claim 1, wherein the base substantially flat base is a square and has a substantially upwardly oriented side wall, contiguous with, and running along the entire perimeter of said substantially flat square base sand wherein said substantially flat grill plate is a substantially flat wire mesh grill structure.

10: The portable, passive-convection cooking oven of claim 1, wherein the base substantially flat base is a square and has a substantially upwardly oriented side wall, contiguous with, and running along the entire perimeter of said substantially flat square base sand wherein said substantially flat grill plate is a substantially flat solid plate.

11: The portable, passive-convection cooking oven of claim 1, wherein said heat distributing convection plate has a substantially flat, conical, heating surface with a single, centrally located convection opening.

12: The portable, passive-convection cooking oven of claim 1, wherein said heat distributing convection plate has a plurality of wedge shaped sections of a cone each laterally joined to another wedge shaped sections of a cone by a linear, concave conduit and wherein said heat distributing convection plate has a single, centrally located convection opening.

13: The portable, passive-convection cooking oven of claim 1, wherein the grill plate has openings along its perimeter, said openings having a diameter larger than the width of the upper horizontal base lip.

14. The portable, passive-convection cooking oven of claim 1, wherein the grill plate has legs supporting it on the upper horizontal base lip.

15. The portable, passive-convection cooking oven of claim 14, wherein the grill plate has a diameter smaller than the diameter of the area surrounded by the upper horizontal base lip, and wherein the legs are horizontal.

16. The portable, passive-convection cooking oven of claim 1, wherein the oven has a grill plate rim supported by the upper horizontal base lip, said grill plate rim having ventilation holes, and the grill plate resting on top of the grill plate rim.
